(19) United States
(12) Patent Application Publication
(10) Pub. No.: US 2024/0326682 A1
(43) Pub. Date: Oct. 3, 2024

(54) SPRINKLING SYSTEM AT WORK SITE AND SPRINKLING METHOD AT WORKSITE

(71) Applicant: Komatsu Ltd., Tokyo (JP)

(72) Inventors: Natsuki Watanabe, Tokyo (JP); Yuta Hoshino, Tokyo (JP)

(73) Assignee: Komatsu Ltd., Tokyo (JP)

(21) Appl. No.: 18/293,805

(22) PCT Filed: Sep. 27, 2022
(86) PCT No.: PCT/JP2022/035964

§ 371 Date: Jan. 31, 2024

(30) Foreign Application Priority Data
Sep. 29, 2021 (JP) 2021-159063

(51) Int. Cl. B60P 3/30; E01H 3/02

(52) U.S. Cl. CPC B60P 3/30; E01H 3/02

(57) ABSTRACT

A sprinkling system at a work site includes: a power device that is mounted on a haul vehicle and generates power for driving a traveling device of the haul vehicle by causing hydrogen to react with oxygen; a storage unit that stores a sprinkling position of the work site; a sprinkling device that is mounted on the haul vehicle and sprays water generated in the power device; and a sprinkling control unit that outputs a control command in such a manner that the sprinkling device sprinkles water to the sprinkling position.

### FIELD

The present disclosure relates to a sprinkling system at a work site and a sprinkling method at a work site.

### BACKGROUND

A fuel cell vehicle as disclosed in Patent Literature 1 is known.

### CITATION LIST

### Patent Literature

Patent Literature 1: Japanese Patent Application Laid-open No. 2020-043662

### SUMMARY

### Technical Problem

In a fuel cell, vehicle driving electric power as a main product and water as a by-product are generated by an electrochemical reaction between hydrogen and oxygen. A technique capable of utilizing the water generated by the electrochemical reaction between hydrogen and oxygen is desired.

An object of the present disclosure is to utilize water generated by a reaction between hydrogen and oxygen.

### Solution to Problem

According to an aspect of the present invention, a sprinkling system at a work site, comprises: a power device that is mounted on a haul vehicle and generates power for driving a traveling device of the haul vehicle by causing hydrogen to react with oxygen; a storage unit that stores a sprinkling position of the work site; a sprinkling device that is mounted on the haul vehicle and sprays water generated in the power device; and a sprinkling control unit that outputs a control command in such a manner that the sprinkling device sprinkles water to the sprinkling position.

### Advantageous Effects of Invention

According to the present disclosure, water generated by a reaction between hydrogen and oxygen is utilized for sprinkling at a work site.

### BRIEF DESCRIPTION OF DRAWINGS

FIG. 1 is a view schematically illustrating a work site of a haul vehicle according to an embodiment.

FIG. 2 is a view schematically illustrating a management system of the work site according to the embodiment.

FIG. 3 is a perspective view schematically illustrating the haul vehicle according to the embodiment.

FIG. 4 is a configuration diagram illustrating the haul vehicle according to the embodiment.

FIG. 5 is a functional block diagram illustrating a sprinkling system according to the embodiment.

FIG. 6 is a view schematically illustrating a sprinkling area according to the embodiment.

FIG. 7 is a flowchart illustrating a control method of the sprinkling system according to the embodiment.

FIG. 8 is a flowchart illustrating a driving method of the sprinkling system according to the embodiment.

FIG. 9 is a block diagram illustrating a computer system according to the embodiment.

FIG. 10 is a configuration diagram illustrating a haul vehicle according to another embodiment.

FIG. 11 is a configuration diagram illustrating a haul vehicle according to another embodiment.

FIG. 12 is a view schematically illustrating a haul vehicle according to another embodiment.

### DESCRIPTION OF EMBODIMENTS

In the following, embodiments according to the present disclosure will be described with reference to the drawings. However, the present disclosure is not limited to the embodiments. Components of the embodiments described in the following can be arbitrarily combined. In addition, there is a case where a part of the components is not used.

### [Work Site]

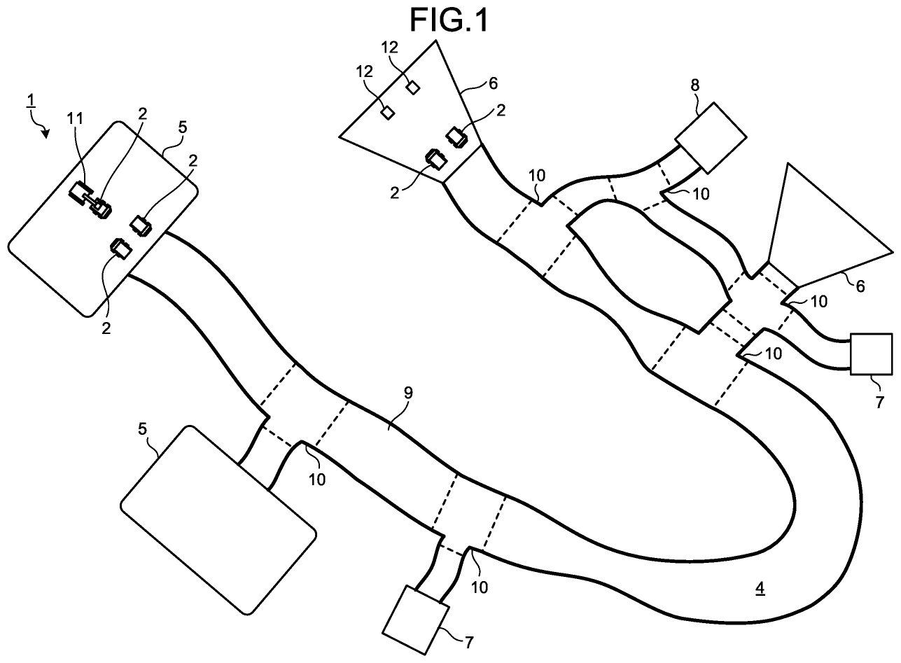

FIG. 1 is a view schematically illustrating a work site 1 of a haul vehicle 2 according to an embodiment. Examples of the work site 1 include a mine or a quarry. The mine is a place or a business site where a mineral is mined. The quarry is a place or a business site where stone is mined. In the work site 1, a plurality of the haul vehicles 2 are operated.

The haul vehicle 2 is a dump truck that travels at the work site 1 and that hauls a load. Examples of the load hauled by the haul vehicle 2 include an excavated object excavated at the work site 1.

The haul vehicle 2 may be an unmanned dump truck that operates in an unmanned manner without depending on driving operation by a driver, or may be a manned dump truck that operates on the basis of driving operation by a driver. In the embodiment, the haul vehicle 2 is assumed to be a manned dump truck.

The work site 1 is a mine in the embodiment. Examples of the mine include a metal mine in which metal is mined, a non-metal mine in which limestone is mined, or a coal mine in which coal is mined.

A traveling area 4 is set at the work site 1. The traveling area 4 is an area where the haul vehicle 2 can travel. The traveling area 4 includes a loading place 5, a soil dumping place 6, a hardstand 7, a gas filling place 8, a traveling path 9, and an intersection 10.

The loading place 5 means an area where loading operation of loading a load onto the haul vehicle 2 is performed. A loader 11 operates in the loading place 5. Examples of the loader 11 include an excavator.

The soil dumping place 6 means an area where soil dumping operation of dumping the load from the haul vehicle 2 is performed. A crusher 12 is provided in the soil dumping place 6.

The hardstand 7 is an area where the haul vehicle 2 is parked.

The gas filling place 8 is an area where filling the haul vehicle 2 with gas is performed.

The traveling path 9 is an area where the haul vehicle 2 heading toward at least one of the loading place 5, the soil dumping place 6, the hardstand 7, or the gas filling place 8 travels. The traveling path 9 is provided in such a manner as to connect at least the loading place 5 and the soil dumping place 6. In the embodiment, the traveling path 9 is connected to each of the loading place 5, the soil dumping place 6, the hardstand 7, and the gas filling place 8.

The intersection 10 means an area where a plurality of traveling paths 9 intersect or an area where one traveling path 9 branches into a plurality of traveling paths 9.

### [Management System]

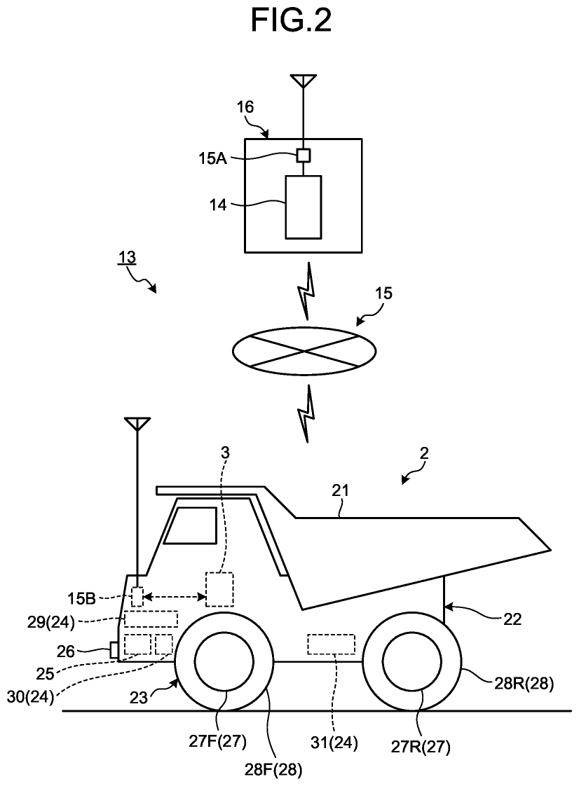

FIG. 2 is a view schematically illustrating a management system 13 of the work site 1 according to the embodiment.

The management system 13 includes a management device 14 and a communication system 15. The management device 14 is installed in control facility 16 of the work site 1. The management device 14 includes a computer system. The haul vehicle 2 includes a control device 3. The control device 3 includes a computer system. The communication system 15 includes wireless communication equipment 15A connected to the management device 14 and wireless communication equipment 15B connected to the control device 3. The management device 14 and the control device 3 of the haul vehicle 2 wirelessly communicate with each other via the communication system 15.

### [Haul Vehicle]

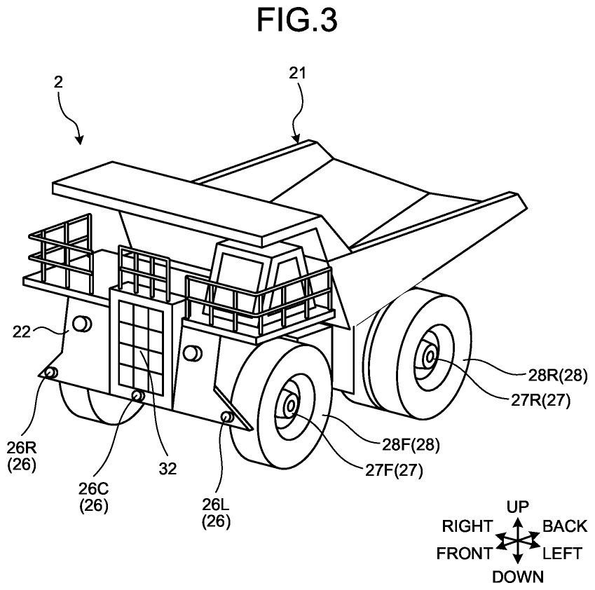

FIG. 3 is a perspective view schematically illustrating the haul vehicle 2 according to the embodiment. As illustrated in FIG. 2 and FIG. 3, the haul vehicle 2 includes a vessel 21, a vehicle body 22, a traveling device 23, a power device 24, a water storage tank 25, a sprinkling spray 26, the wireless communication equipment 15B, and a control device 3.

The vessel (dump body) 21 is a member on which a load is loaded. At least a part of the vessel 21 is arranged above the vehicle body 22. The vessel 21 makes a dumping motion and a lowering motion. The vessel 21 is adjusted to a dumping posture and a loading posture by the dumping motion and the lowering motion. The dumping posture means a posture in which the vessel 21 is raised. The loading posture means a posture in which the vessel 21 is lowered.

The dumping motion is a motion of separating the vessel 21 from the vehicle body 22 and inclining the vessel 21 in a dumping direction. The dumping direction is a rear side of the vehicle body 22. In the embodiment, the dumping motion includes raising a front end portion of the vessel 21 and inclining the vessel 21 backward. By the dumping motion, a loading surface of the vessel 21 is inclined downward toward the rear side.

The lowering motion means a motion of bringing the vessel 21 close to the vehicle body 22. In the embodiment, the lowering motion includes lowering the front end portion of the vessel 21.

In a case of performing the soil dumping operation, the vessel 21 makes the dumping motion in such a manner as to change from the loading posture to the dumping posture. In a case where a load is loaded on the vessel 21, the load is dumped to the rear side from a rear end portion of the vessel 21 by the dumping motion. In a case where the loading operation is performed, the vessel 21 is adjusted to the loading posture.

The vehicle body 22 includes a vehicle body frame. The vehicle body 22 supports the vessel 21. The vehicle body 22 is supported by the traveling device 23. Each of the power device 24, the water storage tank 25, the sprinkling spray 26, the wireless communication equipment 15B, and the control device 3 is mounted on the vehicle body 22.

The traveling device 23 supports the vehicle body 22. The traveling device 23 causes the haul vehicle 2 to travel. The traveling device 23 causes the haul vehicle 2 to move forward or backward. At least a part of the traveling device 23 is arranged below the vehicle body 22. The traveling device 23 includes wheels 27 and tires 28.

The tires 28 are mounted on the wheels 27. The wheels 27 include front wheels 27F and rear wheels 27R. The tires 28 include front tires 28F mounted on the front wheels 27F and rear tires 28R mounted on the rear wheels 27R. The front wheels 27F are steering wheels. The rear wheels 27R are driving wheels.

The power device 24 generates power for driving the traveling device 23 by causing hydrogen to react with oxygen. Driving the traveling device 23 includes rotating the rear wheels 27R that are driving wheels.

In the embodiment, the power device 24 includes a fuel cell 29 that generates electric power by causing electrochemical reaction between hydrogen and oxygen, a condenser 30 that condenses water vapor generated in the fuel cell 29, and a traveling driving motor 31 that generates power for driving the traveling device 23 on the basis of the electric power generated by the fuel cell 29. An outside air introduction port 32 is provided in a front portion of the vehicle body 22. The fuel cell 29 of the power device 24 generates electric power from oxygen included in air introduced through the outside air introduction port 32.

The water storage tank 25 stores water generated in the power device 24. Water vapor is generated by electrochemical reaction between hydrogen and oxygen in the fuel cell 29, and the water vapor generated in the fuel cell 29 is condensed and water is generated in the condenser 30. The water generated in the condenser 30 is stored in the water storage tank 25.

The sprinkling spray 26 is a sprinkling device that sprays the water stored in the water storage tank 25 and sprinkles the water to at least a part of a periphery of the vehicle body 22. The sprinkling spray 26 is arranged at a front portion of the vehicle body 22. The sprinkling spray 26 sprinkles the water to a front side in a traveling direction of the vehicle body 22.

In the embodiment, at least three sprinkling sprays 26 are provided. The three sprinkling sprays 26 include a sprinkling spray 26C, a sprinkling spray 26L, and a sprinkling spray 26R arranged at intervals in a vehicle width direction of the vehicle body 22. The sprinkling spray 26C is arranged at the center in the vehicle width direction of the vehicle body 22. The sprinkling spray 26L is arranged on a left side of the sprinkling spray 26C. The sprinkling spray 26R is arranged on a right side of the sprinkling spray 26C. Note that the number of sprinkling sprays 26 is not limited to three in the present embodiment. The number of sprinkling sprays 26 may be one, two, or four or more. Furthermore, positions where the sprinkling sprays 26 are arranged are not specifically limited, and arrangements at various positions of the vehicle body 22 are possible.

In the vehicle width direction of the vehicle body 22, the sprinkling spray 26C and at least a part of the outside air introduction port 32 are at the same position. The sprinkling spray 26C sprinkles the water to the front side of the outside air introduction port 32.

In the vehicle width direction of the vehicle body 22, the sprinkling spray 26L and at least a part of the front wheel 27F on the left side are at the same position. The sprinkling spray 26L sprinkles the water to the front side of the front wheel 27F on the left side.

In the vehicle width direction of the vehicle body 22, the sprinkling spray 26R and at least a part of the front wheel 27F on the right side are at the same position. The sprinkling spray 26R sprinkles the water to the front side of the front wheel 27F on the right side.

The sprinkling sprays 26 sprinkle the water to the front side of the traveling device 23 in a forward movement of the haul vehicle 2. The sprinkling spray 26L sprinkles the water to the front side of the front wheel 27F on the left side, and the sprinkling spray 26R sprinkles the water to the front side of the front wheel 27F on the right side. As a result, since a road surface in front of the traveling device 23 is wetted, diffusion of powder dust or cloud of dust is controlled in a case where the haul vehicle 2 travels.

In addition, the fuel cell 29 has an electrolyte film through which ions of hydrogen and oxygen are conducted. It is said that moderate humidity is required for the electrolyte film. The sprinkling spray 26C sprinkles the water to the front side of the outside air introduction port 32. As a result, high humidity air is supplied from the outside air introduction port 32 to the fuel cell 29. In addition, a humidifier can be simplified or omitted in the fuel cell 29.

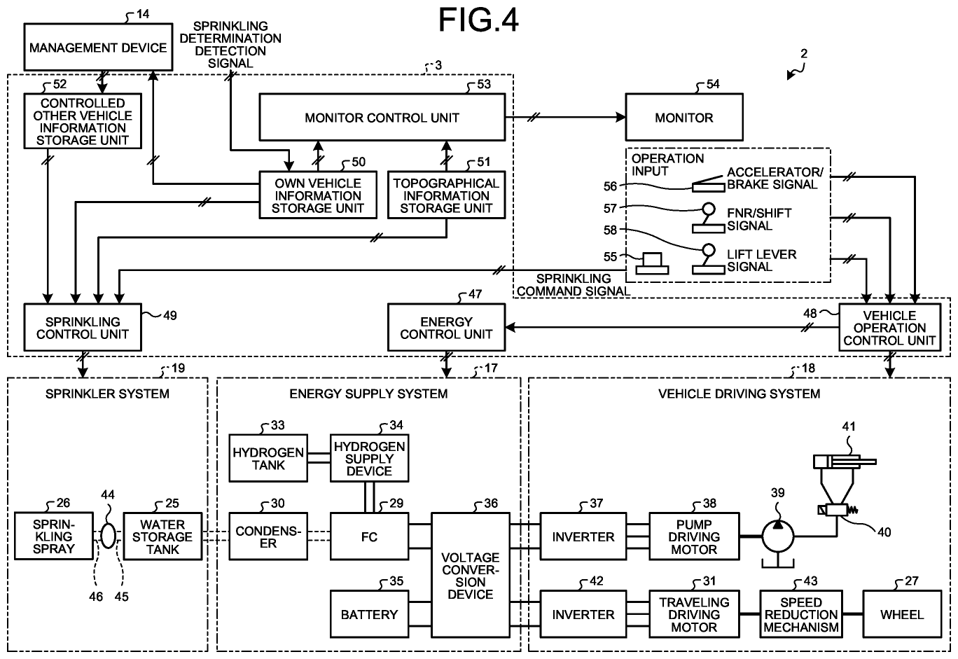

FIG. 4 is a configuration diagram illustrating the haul vehicle 2 according to the embodiment. The haul vehicle 2 includes a monitor 54, an input unit 55, an accelerator brake pedal 56, a shift lever 57, a lift lever 58, an energy supply system 17, a vehicle driving system 18, a sprinkler system 19, and a control device 3.

Each of the monitor 54, the input unit 55, the accelerator brake pedal 56, the shift lever 57, and the lift lever 58 is arranged in a cab of the haul vehicle 2. The monitor 54 displays display data. The input unit 55 generates an input signal by being operated by a driver. When the accelerator brake pedal 56 is operated by the driver, the traveling device 23 is accelerated or decelerated. When the shift lever 57 is operated by the driver, a speed stage of the traveling device 23 is changed, or the forward movement and the backward movement of the traveling device 23 are switched. When the lift lever 58 is operated by the driver, the vessel 21 makes the dumping motion or the lowering motion.

The energy supply system 17 includes a hydrogen tank 33, a hydrogen supply device 34, the fuel cell 29, a battery 35, a voltage conversion device 36, and the condenser 30. The hydrogen supply device 34 supplies hydrogen in the hydrogen tank 33 to the fuel cell 29. The air is supplied to the fuel cell 29 from the outside air introduction port 32. The fuel cell 29 generates electric power by electrochemical reaction between hydrogen and oxygen. The battery 35 stores the electric power generated in the fuel cell 29. The voltage conversion device 36 boosts a voltage of the fuel cell 29 or the battery 35. The condenser 30 condenses the water vapor generated in the fuel cell 29 and generates water.

The vehicle driving system 18 includes an inverter 37, a pump driving motor 38, a hydraulic pump 39, a control valve 40, a hoist cylinder 41, an inverter 42, a traveling driving motor 31, a speed reduction mechanism 43, and the wheels 27. The inverter 37 converts a direct current from the voltage conversion device 36 into a three-phase alternating current and supplies the three-phase alternating current to the pump driving motor 38. The pump driving motor 38 drives the hydraulic pump 39. A hydraulic oil discharged from the hydraulic pump 39 is supplied to the hoist cylinder 41 via the control valve 40. When the hydraulic oil is supplied to the hoist cylinder 41, the hoist cylinder 41 is operated. The hoist cylinder 41 causes the vessel 21 to make the dumping motion or the lowering motion. The inverter 42 converts the direct current from the voltage conversion device 36 into the three-phase alternating current and supplies the three-phase alternating current to the traveling driving motor 31. Rotational force generated by the traveling driving motor 31 is transmitted to the wheels 27 via the speed reduction mechanism 43. When the wheels 27 rotate, the traveling device 23 travels.

The sprinkler system 19 includes the water storage tank 25, the sprinkling sprays 26, a sprinkling pump 44 that supplies the water stored in the water storage tank 25 to the sprinkling sprays 26, a pipe 45 that connects the water storage tank 25 and the sprinkling pump 44, and a pipe 46 that connects the sprinkling pump 44 and the sprinkling sprays 26. The water generated in the condenser 30 is stored in the water storage tank 25. When the sprinkling pump 44 is driven, the water stored in the water storage tank 25 is supplied to the sprinkling sprays 26 via the pipe 45, the sprinkling pump 44, and the pipe 46. The sprinkling sprays 26 spray the water supplied from the water storage tank 25.

The control device 3 includes an energy control unit 47, a vehicle operation control unit 48, a sprinkling control unit 49, an own vehicle information storage unit 50, a topographical information storage unit 51, a controlled other vehicle information storage unit 52, and a monitor control unit 53. The energy control unit 47 controls the energy supply system 17. The vehicle operation control unit 48 controls the vehicle driving system 18. The sprinkling control unit 49 controls the sprinkler system 19. In the embodiment, when the input unit 55 is operated by the driver, the input unit 55 generates a sprinkling command signal as an input signal. In a manual mode, the sprinkling control unit 49 outputs a control command on the basis of the sprinkling command signal from the input unit 55 in such a manner that the water is sprayed from the sprinkling sprays 26. The own vehicle information storage unit 50 stores information related to the own haul vehicle 2 (own vehicle) on which the own vehicle information storage unit 50 is mounted. The topographical information storage unit 51 stores topographical information of the work site. The topographical information of the work site includes, for example, an inclination angle (grade) of the road surface of the traveling path 9. The controlled other vehicle information storage unit 52 stores information transmitted from the management device 14. In addition, the controlled other vehicle information storage unit 52 stores information transmitted from other haul vehicles 2 (other vehicles). The monitor control unit 53 controls the monitor 54.

### [Sprinkling System]

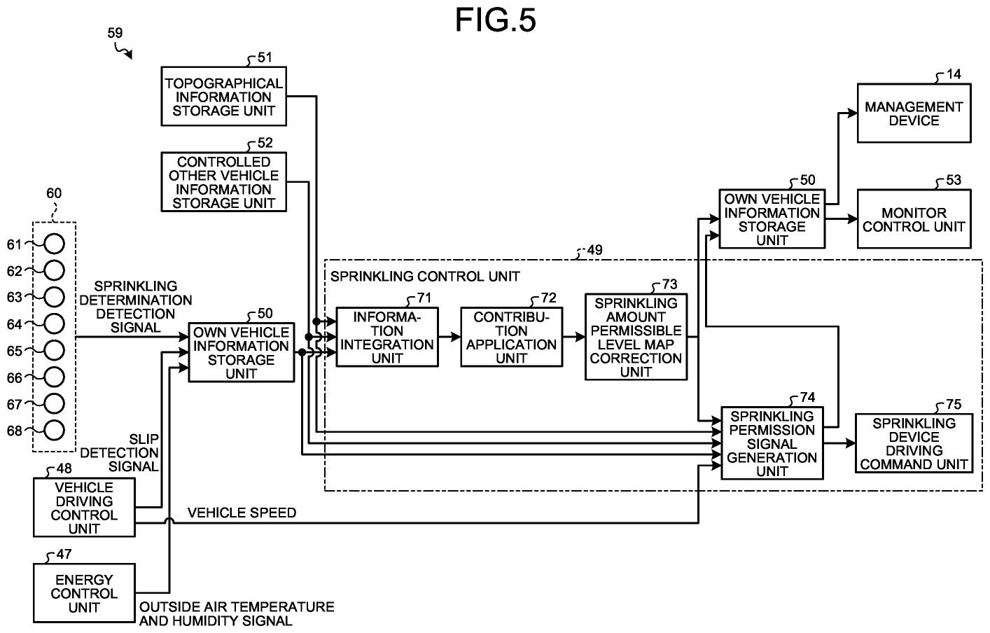

FIG. 5 is a functional block diagram illustrating a sprinkling system 59 according to the embodiment. The sprinkling system 59 includes the management device 14, the energy control unit 47, the vehicle operation control unit 48, the sprinkling control unit 49, the own vehicle information storage unit 50, the topographical information storage unit 51, the controlled other vehicle information storage unit 52, the monitor control unit 53, and a sprinkling determination sensor 60.

The sprinkling determination sensor 60 includes a position sensor 61, a water amount sensor 62, a dust sensor 63, an inclination angle sensor 64, a slip sensor 65, a weather sensor 66, a temperature sensor 67, and a humidity sensor 68. A detection signal of the sprinkling determination sensor 60 (sprinkling determination detection signal) is stored in the own vehicle information storage unit 50. The detection signal of the sprinkling determination sensor 60 (sprinkling determination detection signal) is used for determination of necessity of sprinkling from the sprinkling sprays 26 and control of a sprinkling amount from the sprinkling sprays 26. Note that the sprinkling determination sensor 60 does not need to include all of the position sensor 61, the water amount sensor 62, the dust sensor 63, the inclination angle sensor 64, the slip sensor 65, the weather sensor 66, the temperature sensor 67, and the humidity sensor 68, and only needs to include a sensor necessary for control executed by the sprinkling system 59.

The position sensor 61 detects the position of the haul vehicle 2 on which the position sensor 61 is mounted. In the embodiment, the position sensor 61 detects the position of the haul vehicle 2 by using a global navigation satellite system (GNSS). The position sensor 61 includes a GNSS receiver.

The water amount sensor 62 detects a water amount in the water storage tank 25. Examples of the water amount sensor 62 include a water level sensor or a weight sensor.

The dust sensor 63 detects dust at the work site 1. The dust at the work site 1 includes sand dust. Examples of the dust sensor 63 include a laser sensor (light detection and ranging (LIDAR)) or a radar sensor (radio detection and ranging (RADAR)). Note that the dust sensor 63 may include a camera.

The inclination angle sensor 64 detects an inclination angle of a road surface of the work site 1. The inclination angle sensor 64 detects the inclination angle of the road surface of the work site 1 by detecting an inclination angle of the haul vehicle 2. Examples of the inclination angle sensor 64 include an acceleration sensor, a gyroscope sensor, or an inertial measurement unit (IMU).

The slip sensor 65 detects a slip amount of the rear tires 28R mounted on the rear wheels 27R that are the driving wheels of the traveling device 23. Examples of the slip sensor 65 include an encoder or a resolver. Note that the slip sensor 65 may be arranged in the vehicle driving system 18, and the slip amount may be calculated by arithmetic processing of the vehicle operation control unit 48.

The weather sensor 66 detects the weather at the work site 1. A rain gauge is an example of the weather sensor 66.

The temperature sensor 67 detects a temperature of the work site 1. In the embodiment, the temperature sensor 67 detects a temperature of the road surface of the work site 1. Note that the temperature sensor 67 may be arranged in the energy supply system 17, and the temperature of the work site 1 may be calculated by arithmetic processing of the energy control unit 47.

The humidity sensor 68 detects humidity of the work site 1. Note that the humidity sensor 68 may be arranged in the energy supply system 17, and the temperature of the work site 1 may be calculated by the arithmetic processing of the energy control unit 47.

The sprinkling control unit 49 outputs a control command to the sprinkler system 19 in such a manner that the sprinkling sprays 26 sprinkles the water to the sprinkling area set at the work site 1. The sprinkling area is a partitioned area obtained by subdivision of the entire area of the work site 1 into a square shape, a rectangular shape, a circular shape, or a regular hexagonal shape. Although the sprinkling area is used in the present embodiment, information of a range may not be included. That is, the sprinkling area may be a sprinkling position including information of a position of a target to be sprinkled. The information related to the sprinkling area is transmitted from the management device 14 to the controlled other vehicle information storage unit 52. The controlled other vehicle information storage unit 52 stores the information that is related to the sprinkling area of the work site 1 and transmitted from the management device 14.

The sprinkling control unit 49 outputs a control command to cause the sprinkling sprays 26 to sprinkle the water to the sprinkling area on the basis of a detection signal of the position sensor 61 and the position of the sprinkling area stored in the controlled other vehicle information storage unit 52.

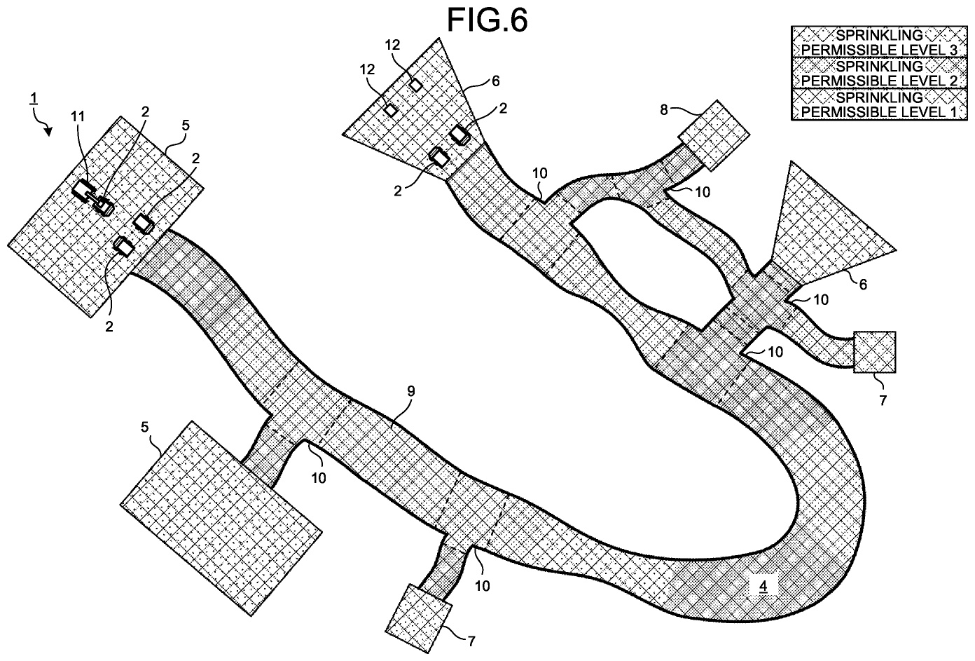

FIG. 6 is a view schematically illustrating the sprinkling area according to the embodiment. A sprinkling permissible level is set for each of a plurality of the sprinkling areas. A sprinkling area of a [sprinkling permissible level 1] is a sprinkling area where sprinkling is always permitted. Examples of the sprinkling area of the [sprinkling permissible level 1] include a place having a drainage groove or a hardstand 7. A sprinkling area of a [sprinkling permissible level 2] is a sprinkling area in which a permissible sprinkling amount is set. Examples of the sprinkling area of the [sprinkling permissible level 2] include a road surface having a predetermined inclination angle or less, a road surface of the normal traveling path 9, and a place where generation of dust (sand dust) is desired to be controlled. In the embodiment, a permissible sprinkling amount for each area is set in accordance with a management and operation policy of the work site 1 in the sprinkling area of the [sprinkling permissible level 2]. The permissible sprinkling amount is planned on the basis of, for example, the number and an operation rate of the haul vehicles 2 equipped with a fuel cell and present at the work site 1, a season, weather information, and the like. A sprinkling area of a [sprinkling permissible level 3] is a sprinkling area where sprinkling is not permitted. Examples of the sprinkling area of the [sprinkling permissible level 3] include a road surface with a steep inclination angle, a road surface that becomes muddy when moisture is contained, a road surface on which a slip is easily caused due to iron plate laying or the like, the loading place 5, the soil dumping place 6, and a place where an influence of sprinkling on a natural environment is strictly limited. The sprinkling permissible level is set in advance according to a situation of the work site 1. The sprinkling control unit 49 controls the sprinkling amount from the sprinkling sprays 26 on the basis of the sprinkling permissible level.

In the following description, the sprinkling permissible level set for each of the plurality of sprinkling areas is appropriately referred to as a sprinkling amount permissible level map.

In the embodiment, the sprinkling control unit 49 controls the sprinkling amount from the sprinkling sprays 26 on the basis of not only the sprinkling amount permissible level map but also sprinkling result information indicating the already-sprinkled sprinkling area and sprinkling amount, and the detection signal of the sprinkling determination sensor 60.

The sprinkling amount permissible level map is transmitted from the management device 14 to the controlled other vehicle information storage unit 52. The controlled other vehicle information storage unit 52 stores not only the sprinkling amount permissible level map transmitted from the management device 14 but also the sprinkling result information indicating the sprinkling area and the sprinkling amount that another haul vehicle 2 has already sprinkled. The sprinkling result information may be transmitted from the other haul vehicle 2 to the own haul vehicle 2, or may be transmitted from the other haul vehicle 2 to the own haul vehicle 2 via the management device 14.

As illustrated in FIG. 5, the sprinkling control unit 49 includes an information integration unit 71, a contribution application unit 72, a sprinkling amount permissible level map correction unit 73, a sprinkling permission signal generation unit 74, and a sprinkling device driving command unit 75.

By using the topographical information of the work site 1 which information is stored in the topographical information storage unit 51, the sprinkling amount permissible level map stored in the controlled other vehicle information storage unit 52, the sprinkling result information of the other haul vehicle 2 which information is stored in the controlled other vehicle information storage unit 52, and the detection signal of the sprinkling determination sensor 60 which signal is stored in the own vehicle information storage unit 50, the information integration unit 71 calculates a required sprinkling amount on the basis of a preset calculation rule, and performs integration into information that can be compared and determined. As an example of the calculation rule, the sprinkling amount is decreased in a case where it is determined that the inclination angle of the road surface is large on the basis of the topographical information of the work site 1 which information is stored in the topographical information storage unit 51 or a detection signal of the inclination angle sensor 64, and the sprinkling amount is increased in a case where it is determined that the inclination angle of the road surface is small. In addition, on the basis of the sprinkling result information of the other haul vehicle 2 which information is stored in the controlled other vehicle information storage unit 52, the sprinkling amount is decreased in a case where it is determined that the other haul vehicle 2 has already performed a large amount of sprinkling, and the sprinkling amount is increased in a case where it is determined that the other haul vehicle 2 has not performed sprinkling. In addition, the sprinkling amount is decreased in a case where it is determined that the water amount of the water storage tank 25 is small on the basis of the detection signal of the water amount sensor 62, and the sprinkling amount is increased in a case where it is determined that the water amount of the water storage tank 25 is large. In addition, on the basis of a detection signal of the dust sensor 63, the sprinkling amount is decreased in a case where it is determined that there is a small amount of dust in the work site 1, and the sprinkling amount is increased in a case where it is determined that there is a lot of dust in the work site 1. In addition, on the basis of a detection signal of the slip sensor 65, the sprinkling amount is decreased in a case where it is determined that a slip amount of the rear tires 28R is large, and the sprinkling amount is increased in a case where it is determined that the slip amount of the rear tires 28R is small. In addition, the sprinkling amount is decreased in a case where the weather is determined to be rainy on the basis of a detection signal of the weather sensor 66, and the sprinkling amount is increased in a case where the weather is determined to be sunny. In addition, the sprinkling amount is decreased in a case where it is determined that a temperature of the road surface is low on the basis of a detection signal of the temperature sensor 67, and the sprinkling amount is increased in a case where it is determined that the temperature of the road surface is high. In addition, the sprinkling amount is decreased in a case where it is determined that humidity is high on the basis of a detection signal of the humidity sensor 68, and the sprinkling amount is increased in a case where it is determined that the humidity is low.

The contribution application unit 72 applies contribution related to necessity of sprinkling from the sprinkling sprays 26 and the sprinkling amount from the sprinkling sprays 26 to the required sprinkling amount integrated by the information integration unit 71. As an example of the contribution, contribution of information related to safety of the work site 1, such as the detection signal of the inclination angle sensor 64 or the required sprinkling amount based on the slip sensor 65 is set high. In addition, the contribution is set to be low in a case where elapsed time from data acquisition timing of the sprinkling result information of the other haul vehicle 2 which information is stored in the controlled other vehicle information storage unit 52 is long, and the contribution is set to be high in a case where the elapsed time is short. In a case where the contribution is low, correlation of the permissible sprinkling amount with respect to the required sprinkling amount calculated by the information integration unit 71 is weakened. In a case where the contribution is high, the correlation of the permissible sprinkling amount with respect to the required sprinkling amount calculated by the information integration unit 71 is made stronger.

The sprinkling amount permissible level map correction unit 73 corrects the sprinkling amount permissible level map on the basis of the contribution applied by the contribution application unit 72. For example, the sprinkling amount permissible level map correction unit 73 increases the permissible sprinkling amount of the sprinkling area of the [sprinkling permissible level 2] in which a large amount of sprinkling is required, and reduces or zeroes out the permissible sprinkling amount of the sprinkling area of the [sprinkling permissible level 2] in which sprinkling is not required.

The sprinkling permission signal generation unit 74 estimates a vehicle passage prediction position from the topographical information of the topographical information storage unit 51, the position sensor 61, and vehicle speed information of the vehicle operation control unit 48, and generates the sprinkling permission signal to the sprinkling device driving command unit 75 on the basis of the corrected sprinkling amount permissible level map and the sprinkling amount permissible level map from the controlled other vehicle information storage unit 52.

The corrected sprinkling amount permissible level map and an accumulated sprinkling amount are stored in the own vehicle information storage unit 50. The monitor control unit 53 causes the monitor 54 to display the corrected sprinkling amount permissible level map. The own vehicle information storage unit 50 transmits the corrected sprinkling amount permissible level map and the accumulated sprinkling amount to the management device 14.

### [Control Method of the Sprinkling System]

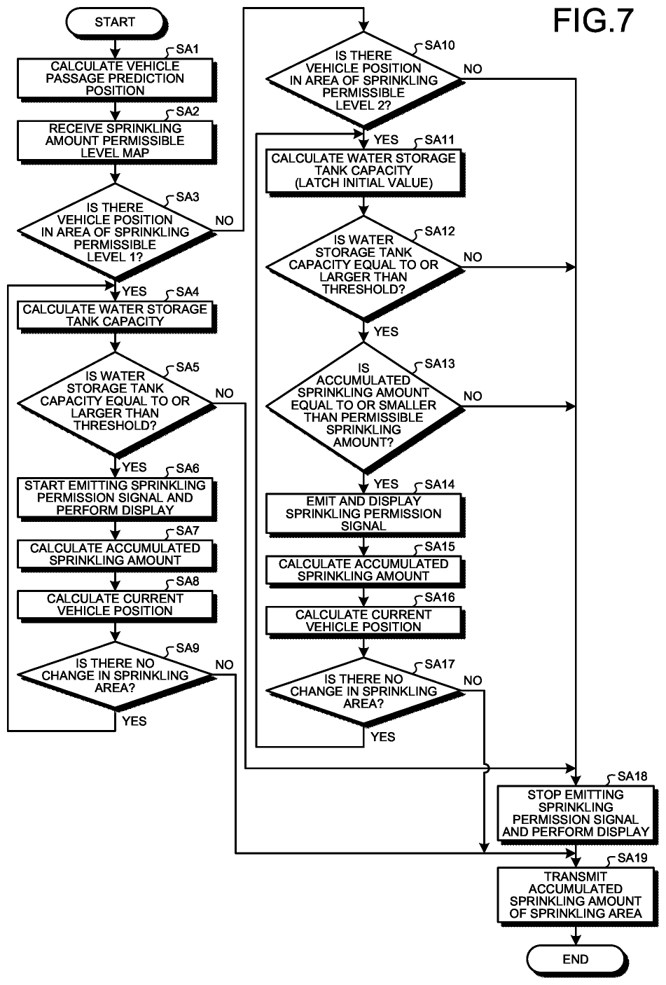

FIG. 7 is a flowchart illustrating a control method of the sprinkling system 59 according to the embodiment. The sprinkling permission signal generation unit 74 calculates the vehicle passage prediction position that is a position where sprinkling is performed from the information of the topographical information storage unit 51, the position sensor 61, and the vehicle speed information of the haul vehicle 2 (Step SA1).

A reference position on the sprinkling amount permissible level map is determined according to the vehicle passage prediction position. There is a possibility that a difference is generated between the position of the haul vehicle 2 and the position where the sprinkled water is sprinkled due to traveling. It is possible to accurately calculate the sprinkled position from the information of the topographical information storage unit 51, the position sensor 61, and the vehicle speed information of the haul vehicle 2. Note that the vehicle passage prediction position may be calculated from the information of the topographical information storage unit 51 and the position sensor 61.

The controlled other vehicle information storage unit 52 receives the sprinkling amount permissible level map from the management device 14 (Step SA2). The sprinkling permission signal generation unit 74 receives the corrected sprinkling amount permissible level map from the sprinkling amount permissible level map correction unit 73 and the sprinkling amount permissible level map from the controlled other vehicle information storage unit 52.

The sprinkling permission signal generation unit 74 determines whether the vehicle passage prediction position exists in the sprinkling area of the [sprinkling permissible level 1] by using the corrected sprinkling amount permissible level map from the sprinkling amount permissible level map correction unit 73 and the sprinkling amount permissible level map from the controlled other vehicle information storage unit 52 (Step SA3).

In a case where it is determined in Step SA3 that the vehicle passage prediction position exists in the sprinkling area of the [sprinkling permissible level 1] (Step SA3: Yes), the sprinkling permission signal generation unit 74 calculates the water storage tank capacity indicating the amount of water stored in the water storage tank 25 on the basis of a detection signal of the water amount sensor 62 (Step SA4).

The sprinkling permission signal generation unit 74 determines whether the water storage tank capacity is equal to or larger than a threshold (Step SA5).

In a case where it is determined in Step SA5 that the water storage tank capacity is equal to or larger than the threshold (Step SA5: Yes), the sprinkling permission signal generation unit 74 transmits a sprinkling permission signal. In addition, the monitor control unit 53 causes the monitor 54 to display the display data indicating that sprinkling is permitted (Step SA6).

The sprinkling permission signal generation unit 74 calculates the accumulated sprinkling amount (Step SA7).

The sprinkling permission signal generation unit 74 calculates a current vehicle position on the basis of the information from the own vehicle information storage unit 50 and the information of the vehicle speed from the vehicle operation control unit 48 (Step SA8).

The sprinkling permission signal generation unit 74 confirms whether the sprinkling area is changed from the topographical information of the topographical information storage unit 51 and the position sensor 61 (Step SA9).

In a case where it is determined in Step SA9 that there is no change in the sprinkling area (Step SA9: Yes), the processing returns to Step SA4.

In a case where it is determined in Step SA3 that the vehicle passage prediction position does not exist in the sprinkling area of the [sprinkling permissible level 1] (Step SA3: No), the sprinkling permission signal generation unit 74 determines whether the vehicle passage prediction position exists in the sprinkling area of the [sprinkling permissible level 2] (Step SA10).

In a case where it is determined in Step SA10 that the vehicle passage prediction position exists in the sprinkling area of the [sprinkling permissible level 2] (Step SA10: Yes), the sprinkling permission signal generation unit 74 calculates the water storage tank capacity on the basis of the detection signal of the water amount sensor 62. An initial value of the water storage tank capacity is latched in order to calculate the accumulated sprinkling amount (Step SA11).

The sprinkling permission signal generation unit 74 determines whether the water storage tank capacity is equal to or larger than the threshold (Step SA12).

In a case where it is determined in Step SA12 that the water storage tank capacity is equal to or larger than the threshold (Step SA12: Yes), the sprinkling permission signal generation unit 74 determines whether the accumulated sprinkling amount is equal to or smaller than the permissible sprinkling amount (Step SA13).

In a case where it is determined in Step SA13 that the accumulated sprinkling amount is equal to or smaller than the permissible sprinkling amount (Step SA13: Yes), the sprinkling permission signal generation unit 74 transmits the sprinkling permission signal. In addition, the monitor control unit 53 causes the monitor 54 to display the display data indicating that sprinkling is permitted (Step SA14).

The sprinkling permission signal generation unit 74 calculates the accumulated sprinkling amount (Step SA15).

The sprinkling permission signal generation unit 74 calculates the current vehicle position on the basis of the information from the own vehicle information storage unit 50 and the information of the vehicle speed from the vehicle operation control unit 48 (Step SA16).

The sprinkling permission signal generation unit 74 confirms whether the sprinkling area is changed from the topographical information of the topographical information storage unit 51 and the position sensor 61 (Step SA17).

In a case where it is determined in Step SA17 that there is no change in the sprinkling area (Step SA17: Yes), the processing returns to Step SA11.

In a case where it is determined in Step SA5 that the water storage tank capacity is not equal to or larger than the threshold (Step SA5: No), in a case where it is determined in Step SA10 that the vehicle passage prediction position does not exist in the sprinkling area of the [sprinkling permissible level 2] (Step SA10: No), in a case where it is determined in Step SA12 that the water storage tank capacity is not equal to or larger than the threshold (Step SA12: No), and in a case where it is determined in Step SA13 that the accumulated sprinkling amount is not equal to or smaller than the permissible sprinkling amount (Step S13: No), the sprinkling permission signal generation unit 74 stops the sprinkling permission signal. In addition, the monitor control unit 53 causes the monitor 54 to display the display data indicating that sprinkling is not permitted (Step SA18).

The sprinkling permission signal generation unit 74 transmits the accumulated sprinkling amount of the sprinkling area to the own vehicle information storage unit 50 (Step SA19).

### [Driving Method of the Sprinkling System]

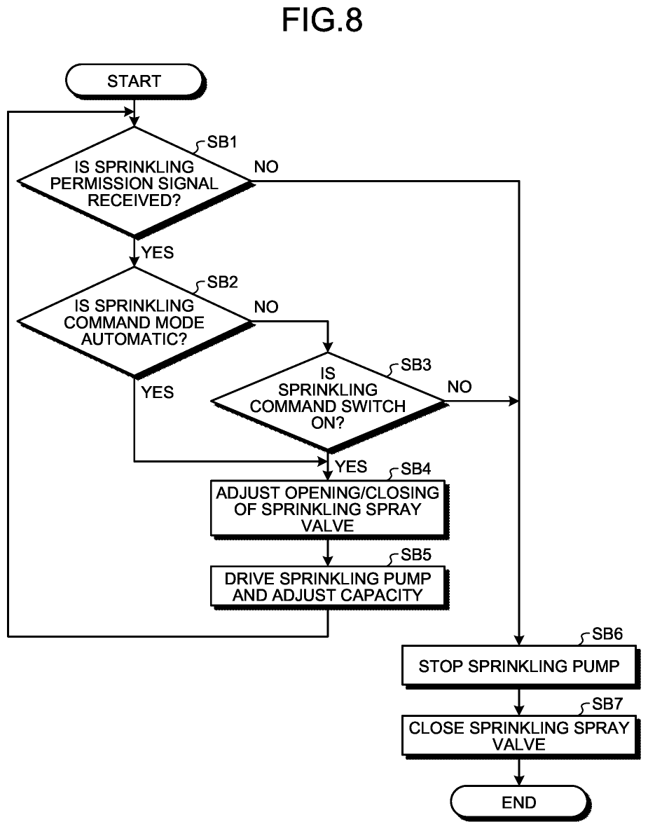

FIG. 8 is a flowchart illustrating the driving method of the sprinkling system 59 according to the embodiment according to the embodiment. The sprinkling device driving command unit 75 determines whether the sprinkling permission signal generation unit 74 transmits the sprinkling permission signal (Step SB1).

In a case where it is determined in Step SB1 that the sprinkling permission signal is transmitted (Step SB1: Yes), the sprinkling device driving command unit 75 determines whether the sprinkling command mode is automatic (Step SB2).

In a case where it is determined in Step SB2 that the sprinkling command mode is not automatic (Step SB2: No), the sprinkling device driving command unit 75 determines whether a sprinkling command switch of the input unit 55 is ON (Step SB3).

In a case where it is determined in Step SB2 that the sprinkling command mode is automatic (Step SB2: Yes), or in a case where it is determined in Step SB3 that the sprinkling command switch is ON (Step SB3: Yes), the sprinkling device driving command unit 75 performs an opening/closing adjustment of valves of the sprinkling sprays 26 (Step SB4).

In addition, the sprinkling device driving command unit 75 drives the sprinkling pump 44 and adjusts the capacity of the sprinkling pump 44 (Step SB5), and returns to the processing of Step SB1.

In a case where it is determined in Step SB1 that the sprinkling permission signal is not transmitted (Step SB1: No), or in a case where it is determined in Step SB3 that the sprinkling command switch is not ON (Step SB3: No), the sprinkling device driving command unit 75 stops the sprinkling pump 44 (Step SB6).

In addition, the sprinkling device driving command unit 75 closes the valves of the sprinkling sprays 26 (Step SB7).

The sprinkling sprays 26 sprinkle the water to the sprinkling area under the control of the sprinkling device driving command unit 75.

Note that the sprinkling sprays 26 may sprinkle the water in an automatic mode on the basis of the sprinkling permission signal from the sprinkling permission signal generation unit 74. The sprinkling sprays 26 may sprinkle the water in a manual mode on the basis of the sprinkling permission signal from the sprinkling permission signal generation unit 74 and the input signal from the input unit 55.

### [Computer System]

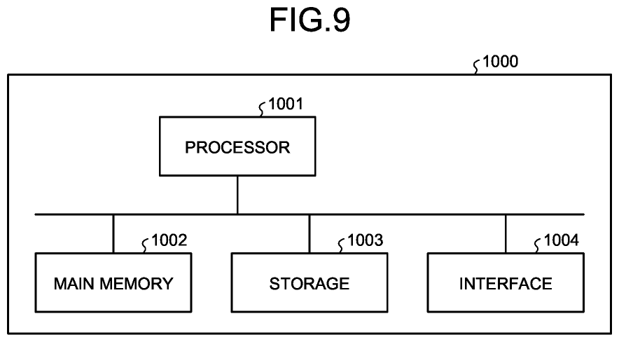

FIG. 9 is a block diagram illustrating a computer system 1000 according to the embodiment. Each of the above-described management device 14 and control device 3 includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. The function of each of the management device 14 and the control device 3 described above is stored in the storage 1003 as a computer program. The processor 1001 reads the computer program from the storage 1003, develops the computer program in the main memory 1002, and executes the above-described processing according to the computer program. Note that the computer program may be distributed to the computer system 1000 through a network.

According to the above-described embodiment, the computer program or the computer system 1000 can execute causing electrochemical reaction between hydrogen and oxygen and generating power for driving the traveling device 23 of the haul vehicle 2, setting a sprinkling position of the work site 1, and spraying water generated in the electrochemical reaction between hydrogen and oxygen from the sprinkling sprays 26 in such a manner that the water is sprinkled at the sprinkling position.

In addition, according to the above-described embodiment, the computer program or the computer system 1000 can execute detection of a position of the haul vehicle 2, and spraying of the water from the sprinkling sprays 26 on the basis of the position of the haul vehicle 2 and the sprinkling position.

In addition, according to the above-described embodiment, the computer program or the computer system 1000 can execute setting of a permissible level of the sprinkling amount for each of a plurality of the sprinkling positions and control of the sprinkling amount from the sprinkling sprays 26 on the basis of the permissible level.

In addition, according to the above-described embodiment, the computer program or the computer system 1000 can execute control of the sprinkling amount from the sprinkling sprays 26 on the basis of the sprinkling result information indicating at least one of the already-sprinkled sprinkling position or sprinkling amount, and the detection signal of the sprinkling determination sensor 60.

In addition, the computer program or the computer system 1000 can execute displaying of the sprinkling position on the monitor 54 mounted on the haul vehicle 2 according to the above-described embodiment.

In addition, according to the above-described embodiment, the computer program or the computer system 1000 can execute spraying of the water from the sprinkling sprays 26 on the basis of the input signal from the input unit 55 mounted on the haul vehicle 2.

### [Effect]

As described above, according to the embodiment, the sprinkling system 59 of the work site 1 includes the power device 24 that is mounted on the haul vehicle 2 and that causes hydrogen to react with oxygen and generates power for driving the traveling device 23 of the haul vehicle 2, the controlled other vehicle information storage unit 52 that stores the sprinkling positions of the work site 1, the sprinkling sprays 26 that are mounted on the haul vehicle 2 and spray the water generated in the power device 24, and the sprinkling control unit 49 that outputs a control command in such a manner that the sprinkling sprays 26 sprinkle the water at the sprinkling position.

As a result, the water generated by the electrochemical reaction between hydrogen and oxygen is used for sprinkling at the work site 1. Furthermore, by sprinkling to the predetermined sprinkling position of the work site 1, diffusion of powder dust or cloud of dust at the work site 1 is controlled.

The position of the haul vehicle 2 is detected by the position sensor 61. The sprinkling control unit 49 can output the control command in such a manner that the water is sprinkled to the sprinkling position on the basis of the detection signal of the position sensor 61 and the sprinkling positions stored in the controlled other vehicle information storage unit 52.

A sprinkling permissible level is set for each of the plurality of sprinkling positions. The sprinkling control unit 49 controls the sprinkling amount from the sprinkling sprays 26 on the basis of the sprinkling permissible level. As a result, it is possible to sprinkle a large amount of water to a sprinkling position where a large amount of water needs to be sprinkled, and it is possible to sprinkle an appropriate amount of water to a sprinkling position where sprinkling of a large amount of water is unfavorable.

The sprinkling control unit 49 controls the sprinkling amount from the sprinkling sprays 26 on the basis of the sprinkling result information indicating the sprinkling position and the sprinkling amount already sprinkled by the other haul vehicle 2 and the detection signal of the sprinkling determination sensor 60. As a result, for example, excessive sprinkling to the sprinkling position already sprinkled by the other haul vehicle 2 is controlled. In addition, it is possible to sprinkle water of an appropriate sprinkling amount on the basis of the detection signal of the sprinkling determination sensor 60.

The sprinkling positions are displayed on the monitor 54 mounted on the haul vehicle 2. In the embodiment, the sprinkling amount permissible level map is displayed on the monitor 54. As a result, a driver of the haul vehicle 2 can confirm how much water should be sprinkled at which sprinkling position.

When the input unit 55 mounted on the haul vehicle 2 is operated, the sprinkling command signal is generated as the input signal. In a case of the manual mode, the sprinkling control unit 49 can output the control command on the basis of the input signal from the input unit 55.

### Other Embodiments

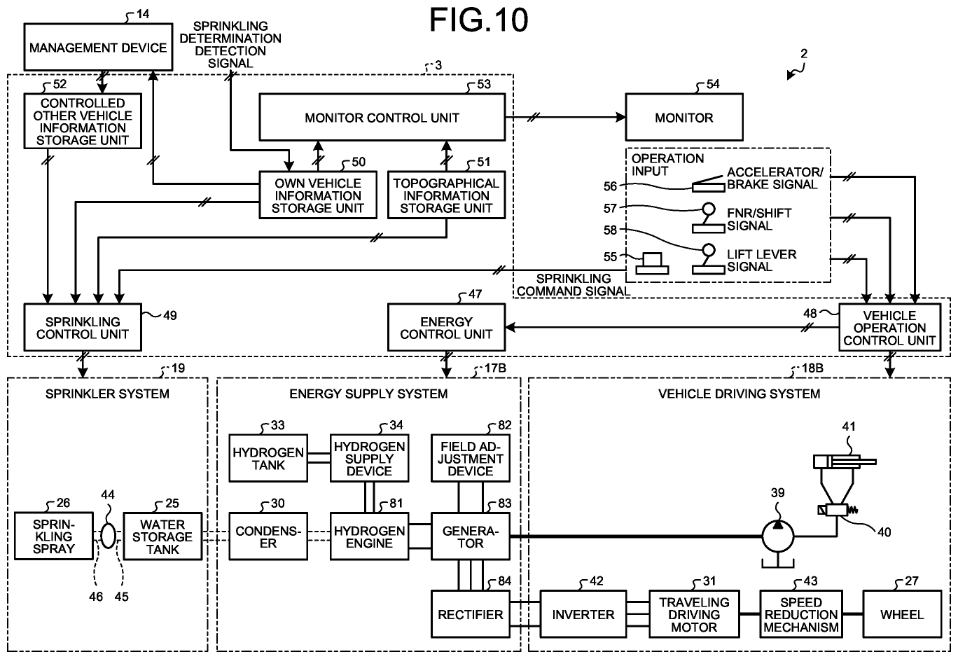

FIG. 10 is a configuration diagram 10 illustrating a haul vehicle 2 according to another embodiment. In the embodiment described above, the power device 24 of the haul vehicle 2 includes the fuel cell 29. As illustrated in FIG. 10, a power device 24 (energy supply system 17B) of the haul vehicle 2 may include a hydrogen engine 81. The hydrogen engine 81 generates power by causing combustion reaction between hydrogen and oxygen.

The hydrogen engine 81 includes a cylinder block and a piston. Air including hydrogen and oxygen is supplied to a combustion chamber defined by the cylinder block and the piston. Hydrogen is stored in a hydrogen tank 33 and supplied to the hydrogen engine 81 by a hydrogen supply device 34. The air is supplied to the hydrogen engine 81 from an outside air introduction port 32.

Water vapor generated in the hydrogen engine 81 is condensed by a condenser 30. The water generated in the condenser 30 is stored in the water storage tank 25.

The energy supply system 17B illustrated in FIG. 10 includes a generator 83 that generates electric power on the basis of power generated by the hydrogen engine 81. The generator 83 is connected to a field adjustment device 82. The electric power generated by the generator 83 is supplied to a vehicle driving system 18B via a rectifier 84. As in the above-described embodiment, the vehicle driving system 18B includes an inverter 42, a traveling driving motor 31, a speed reduction mechanism 43, and wheels 27. The traveling driving motor 31 generates power on the basis of the electric power generated by the generator 83.

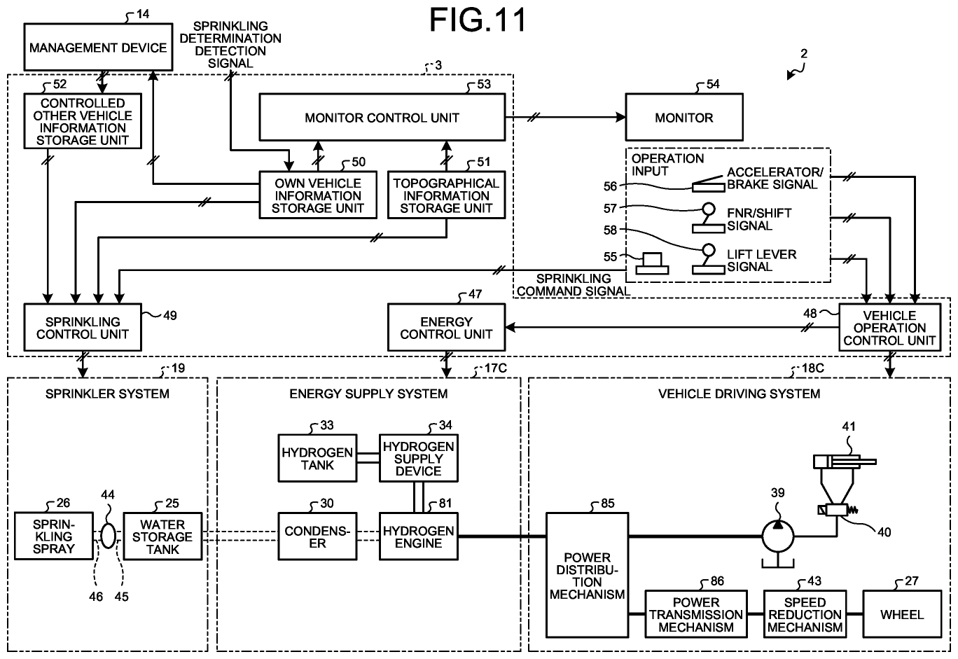

FIG. 11 is a configuration diagram 10 illustrating a haul vehicle 2 according to another embodiment. As in the example illustrated in FIG. 10, an energy supply system 17C includes a hydrogen engine 81. A vehicle driving system 18C includes a power distribution mechanism 85 and a power transmission mechanism 86. The power distribution mechanism 85 is connected to the hydrogen engine 81. The power generated by the hydrogen engine 81 is distributed to a hydraulic pump 39 and the power transmission mechanism 86. The power distributed to the power transmission mechanism 86 is transmitted to the wheels 27 via a speed reduction mechanism 43. As illustrated in FIG. 11, the energy supply system 17C may not include a generator.

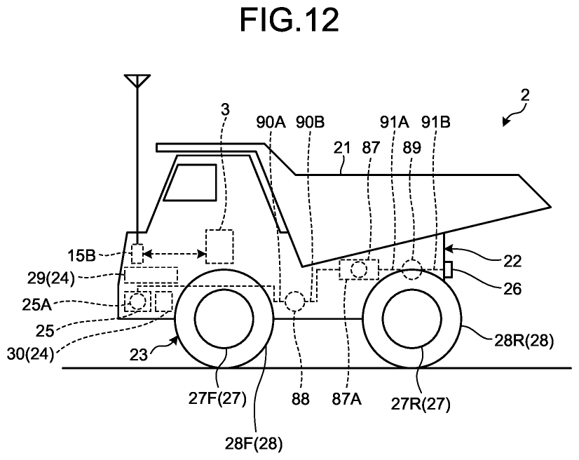

FIG. 12 is a view schematically illustrating a haul vehicle 2 according to another embodiment. As illustrated in FIG. 12, a sprinkling spray 26 may be provided at a rear portion of a vehicle body 22. In a case where a power device 24 and a water storage tank 25 are arranged at a front portion of the vehicle body 22, a sprinkling tank 87 may be arranged at a position different from that of the water storage tank 25. The sprinkling tank 87 is arranged behind the water storage tank 25 in the vehicle body 22.

In the example illustrated in FIG. 12, the haul vehicle 2 includes a first sprinkling pump 88 that supplies water stored in the water storage tank 25 to the sprinkling tank 87, and a second sprinkling pump 89 that supplies water stored in the sprinkling tank 87 to the sprinkling spray 26. The water storage tank 25 and the first sprinkling pump 88 are connected via a pipe 90A. The first sprinkling pump 88 and the sprinkling tank 87 are connected via a pipe 90B. The sprinkling tank 87 and the second sprinkling pump 89 are connected via a pipe 91A. The second sprinkling pump 89 and the sprinkling spray 26 are connected via a pipe 91B. The sprinkling spray 26 sprays water supplied from the water storage tank 25 to the sprinkling tank 87.

In addition, a water receiving port 87A may be connected to the sprinkling tank 87. Water is supplied to the water receiving port 87A from the outside of the vehicle body 22. In a case where a water amount in the sprinkling tank 87 is small, water may be supplied to the sprinkling tank 87 via the water receiving port 87A. Similarly, a water receiving port 25A through which water is supplied from the outside of the vehicle body 22 may be connected to the water storage tank 25.

In addition, in a vehicle width direction of the vehicle body 22, a sprinkling spray 26L and at least a part of a rear wheel 27R that is a driving wheel are located at the same position. The sprinkling spray 26L may perform sprinkling to a front side of the rear wheel 27R on a left side. In addition, in the vehicle width direction of the vehicle body 22, a sprinkling spray 26R and at least a part of a rear wheel 27R that is a driving wheel are located at the same position. The sprinkling spray 26L may perform sprinkling to a front side of the rear wheel 27R on a right side.

In addition, the sprinkling spray 26 may change an angle formed by a sprinkling direction of the sprinkling spray 26 and a front direction of the haul vehicle 2 in a timely manner on the basis of rotation speed information of right and left wheels of a steering input device or a traveling device 23 when the vehicle body 22 turns.

In addition, the sprinkling device is the sprinkling spray 26 in the embodiment described above. In another embodiment, a sprinkling device may be another device having a sprinkling function.

### REFERENCE SIGNS LIST

1 WORK SITE
2 HAUL VEHICLE
3 CONTROL DEVICE
4 TRAVELING AREA
5 LOADING PLACE
6 SOIL DUMPING PLACE
7 HARDSTAND
8 GAS FILLING PLACE
9 TRAVELING PATH
10 INTERSECTION
11 LOADER
12 CRUSHER
13 MANAGEMENT SYSTEM
14 MANAGEMENT DEVICE
15 COMMUNICATION SYSTEM
15A WIRELESS COMMUNICATION EQUIPMENT
15B WIRELESS COMMUNICATION EQUIPMENT
16 CONTROL FACILITY
17 ENERGY SUPPLY SYSTEM
17B ENERGY SUPPLY SYSTEM
17C ENERGY SUPPLY SYSTEM
18 VEHICLE DRIVING SYSTEM
18B VEHICLE DRIVING SYSTEM
18C VEHICLE DRIVING SYSTEM
19 SPRINKLER SYSTEM
21 VESSEL
22 VEHICLE BODY
23 TRAVELING DEVICE
24 POWER DEVICE
25 WATER STORAGE TANK
25A WATER RECEIVING PORT
26 SPRINKLING SPRAY
26C SPRINKLING SPRAY
26L SPRINKLING SPRAY
26R SPRINKLING SPRAY
27 WHEEL
27F FRONT WHEEL
27R REAR WHEEL
28 TIRE
28F FRONT TIRE
28R REAR TIRE
29 FUEL CELL
30 CONDENSER
31 TRAVELING DRIVING MOTOR
32 OUTSIDE AIR INTRODUCTION PORT
33 HYDROGEN TANK
34 HYDROGEN SUPPLY DEVICE
35 BATTERY
36 VOLTAGE CONVERSION DEVICE
37 INVERTER
38 PUMP DRIVING MOTOR
39 HYDRAULIC PUMP
40 CONTROL VALVE
41 HOIST CYLINDER
42 INVERTER
43 SPEED REDUCTION MECHANISM
44 SPRINKLING PUMP
45 PIPE
46 PIPE
47 ENERGY CONTROL UNIT
48 VEHICLE OPERATION CONTROL UNIT
49 SPRINKLING CONTROL UNIT
50 OWN VEHICLE INFORMATION STORAGE UNIT
51 TOPOGRAPHICAL INFORMATION STORAGE UNIT
52 CONTROLLED OTHER VEHICLE INFORMATION STORAGE UNIT
53 MONITOR CONTROL UNIT
54 MONITOR
55 INPUT UNIT
56 ACCELERATOR BRAKE PEDAL
57 SHIFT LEVER
58 LIFT LEVER
59 SPRINKLING SYSTEM
60 SPRINKLING DETERMINATION SENSOR
61 POSITION SENSOR
62 WATER AMOUNT SENSOR
63 DUST SENSOR
64 INCLINATION ANGLE SENSOR
65 SLIP SENSOR
66 WEATHER SENSOR
67 TEMPERATURE SENSOR
68 HUMIDITY SENSOR
71 INFORMATION INTEGRATION UNIT
72 CONTRIBUTION APPLICATION UNIT
73 SPRINKLING AMOUNT PERMISSIBLE LEVEL MAP CORRECTION UNIT
74 SPRINKLING PERMISSION SIGNAL GENERATION UNIT
75 SPRINKLING DEVICE DRIVING COMMAND UNIT
81 HYDROGEN ENGINE
82 FIELD ADJUSTMENT DEVICE
83 GENERATOR
84 RECTIFIER
85 POWER DISTRIBUTION MECHANISM
86 POWER TRANSMISSION MECHANISM
87 SPRINKLING TANK
87A WATER RECEIVING PORT
88 FIRST SPRINKLING PUMP
89 SECOND SPRINKLING PUMP
90A PIPE
90B PIPE
91A PIPE
91B PIPE
1000 COMPUTER SYSTEM
1001 PROCESSOR
1002 MAIN MEMORY
1003 STORAGE
1004 INTERFACE

1. A sprinkling system at a work site, comprising:
a power device that is mounted on a haul vehicle and generates power for driving a traveling device of the haul vehicle by causing hydrogen to react with oxygen;
a storage unit that stores a sprinkling position of the work site;
a sprinkling device that is mounted on the haul vehicle and sprays water generated in the power device; and
a sprinkling control unit that outputs a control command in such a manner that the sprinkling device sprinkles water to the sprinkling position.

2. The sprinkling system of a work site according to claim 1, further comprising
a position sensor that detects a position of the haul vehicle, wherein
the sprinkling control unit outputs the control command on a basis of a detection signal of the position sensor and the sprinkling position stored in the storage unit.

3. The sprinkling system of a work site according to claim 1, wherein
a sprinkling permissible level is set for each of a plurality of the sprinkling positions, and
the sprinkling control unit controls a sprinkling amount from the sprinkling device on a basis of the sprinkling permissible level.

4. The sprinkling system of a work site according to claim 3, wherein
the sprinkling control unit controls the sprinkling amount from the sprinkling device on a basis of sprinkling result information indicating an already-sprinkled sprinkling position and sprinkling amount and a detection signal of a sprinkling determination sensor.

5. The sprinkling system of a work site according to claim 4, further comprising:
a water storage tank that stores water generated in the power device and sprinkled from the sprinkling device; and
a water amount sensor that detects a water amount of the water storage tank, wherein
the sprinkling determination sensor includes the water amount sensor.

6. The sprinkling system of a work site according to claim 4, further comprising
a dust sensor that detects dust at the work site, wherein
the sprinkling determination sensor includes the dust sensor.

7. The sprinkling system of a work site according to claim 4, further comprising
an inclination angle sensor that detects an inclination angle of a road surface of the work site, wherein
the sprinkling determination sensor includes the inclination angle sensor.

8. The sprinkling system of a work site according to claim 4, further comprising
a slip sensor that detects a slip amount of tires mounted on driving wheels of the traveling device, wherein
the sprinkling determination sensor includes the slip sensor.

9. The sprinkling system of a work site according to claim 4, further comprising
a weather sensor that detects weather at the work site, wherein
the sprinkling determination sensor includes the weather sensor.

10. The sprinkling system of a work site according to claim 4, further comprising
a temperature sensor that detects a temperature of a road surface of the work site, wherein
the sprinkling determination sensor includes the temperature sensor.

11. The sprinkling system of a work site according to claim 4, further comprising
a humidity sensor that detects humidity at the work site, wherein
the sprinkling determination sensor includes the humidity sensor.

12. The sprinkling system of a work site according to claim 1, further comprising
a monitor that is mounted on the haul vehicle and that displays the sprinkling position.

13. The sprinkling system of a work site according to claim 1, further comprising
an input unit mounted on the haul vehicle, wherein
the sprinkling control unit outputs the control command on a basis of an input signal from the input unit.

14. A sprinkling method at a work site, comprising:
generating power for driving a traveling device of a haul vehicle by causing hydrogen to react with oxygen;
setting a sprinkling position at the work site; and
spraying water generated in the reaction from a sprinkling device in such a manner that water is sprinkled to the sprinkling position.

15. The sprinkling method at a work site according to claim 14, further comprising:
detecting a position of the haul vehicle; and
spraying the water from the sprinkling device on a basis of the position of the haul vehicle and the sprinkling position.

16. The sprinkling method at a work site according to claim 14, wherein
a permissible level of a sprinkling amount is set for each of a plurality of the sprinkling positions, and
the sprinkling amount from the sprinkling device is controlled on a basis of the permissible level.

17. The sprinkling method at a work site according to claim 16, further comprising
controlling the sprinkling amount from the sprinkling device on a basis of sprinkling result information indicating at least one of already-sprinkled sprinkling position or sprinkling amount, and a detection signal of a sprinkling determination sensor.

18. The sprinkling method at a work site according to claim 14, further comprising
displaying the sprinkling position on a monitor mounted on the haul vehicle.

19. The sprinkling method at a work site according to claim 14, further comprising
spraying the water from the sprinkling device on a basis of an input signal from an input unit mounted on the haul vehicle.
